(19) United States
(12) Patent Application Publication
(10) Pub. No.: US 2016/0065410 A1
(43) Pub. Date: Mar. 3, 2016

(54) SYSTEM AND METHOD OF PEER DEVICE DIAGNOSIS

(71) Applicant: CrowdCare Corporation, Richmond Hill (CA)

(72) Inventors: Jeffrey Brunet, Aurora (CA); Yousuf Chowdhary, Maple (CA); Ian Collins, Markham (CA)

(21) Appl. No.: 14/839,598

(22) Filed: Aug. 28, 2015

Related U.S. Application Data
(60) Provisional application No. 62/043,910, filed on Aug. 29, 2014.

(51) Int. Cl. H04L 12/24; H04W 24/02; H04L 29/08

(52) U.S. Cl. CPC H04L 41/0869; H04L 41/084; H04L 67/104; H04W 24/02

(57) ABSTRACT

A method is provided to enable a target device to be conformed with a reference device. After a peer-to-peer network connection is established between the target device and the reference device, profiles are taken of the target device and the reference device using diagnostic applications on the devices. The parameter values of the profiles are compared to establish a delta. Using this delta, at least one parameter value of the reference device profile is transmitted to the target device. That parameter value is automatically reset or adjusted to match or approximate the reference device profile. A method is also provided for using a first device to mediate the diagnosis and fixing of a second device.

### PRIORITY

This application claims the benefit of U.S. Provisional Application No. 62/043,910, filed Aug. 29, 2014, the disclosure of which is incorporated herein by reference.

### FIELD OF THE INVENTION

The invention in general relates to customer care systems for electronic devices and in particular relates to problem diagnosis in electronic communication devices.

### BACKGROUND

Existing customer care and tech support tools are inefficient for subscribers and costly for operators. When customers encounter a problem with their device they have to endure lengthy phone calls, navigating decision trees, and website or forum searches that deliver static un-personalized content with little hope for finding an accurate resolution to their problem.

As manufacturers and operators try to reduce the cost of customer support by cutting call centers and support jobs the wait times become longer and the problem resolution even more torturous for the customers. Consumers today are busier and less patient than ever—they need quick, accurate, and personalized solutions to their problems. This has encouraged people to seek help from other users, before they call the manufacturers and service providers. Self help is gaining in popularity, and peer groups are an example of people helping each other. Forums and similar platforms enable people to share experiences and tell others how they fixed a problem.

As markets become saturated companies are in a fierce battle with their rivals to create levels of differentiation beyond price. Fast resolution to customer problems/complaints results in more satisfied customers which in turn increases customer retention. Manufacturers and operators are deploying self-care solutions that focus on call volume reduction or call avoidance which helps towards lowering the cost of customer support. Existing self-care systems enable customers to check their balances, view financial transactions and invoices, modify personal details, change billing cycle dates, modify payment methods, change service parameters, and most importantly trouble shoot some of the basic issues that they may encounter; but there is ample room fur improvement.

Self-care methods typically present unfiltered information that lacks context. Thus a user is required to sift through massive amounts of data manually to get to the relevant information keeping the context of the problem in mind. Therefore a user can easily miss the solution information that may be buried deep in the pile. In addition the user still needs to manually try several solutions to find one that actually fits their unique situation and provides a fix to their problem.

There is an overall lack of automation in such methods and other areas are in need of improvement to provide comprehensive self-care capabilities for customers.

### SUMMARY

Broadly speaking, the system and the method provide a codified knowledgebase where rules are used to diagnose a peer device, and/or fine tune the performance of another peer device. Thus a first device (e.g. a Smartphone) which is functioning properly may be used to diagnose a second device (e.g. a tablet) which is not functioning properly. An app may be launched on a first device. The app may also be launched on a second device and a Bluetooth connection established between the first device and the second device. The app allows the first device to be profiled. For example, the app may have an agent that has the capability to provide a user with an interface using which the user may be able profile a device in order to diagnose another peer device.

The device profile for example may provide device make, device model, OS version, language, operator, location, settings. Information that can be gathered from the device may include but is not limited to: the device make, model and manufacture information, OS and firmware versions; applications (commonly referred to as “apps”) installed on the device; apps and processes running on the device; certificates on the device; user profile information; the character of any passcode used to authenticate a user (e.g. whether a password/passcode is used and the relative strength of that password, such as the number of characters); information regarding whether the device operating system has been tampered with by the user (e.g. an iOS device has been jailbroken, or a Google Android device has been rooted); and the data usage e.g. the amount of MB or GB used for a given billing period, the amount of data used while roaming, or the relative amount compared to a data plan used by the user.

Data may also be added to the device profile from error logs for example types of errors, number of errors in an error log, severity of errors, number and frequency of crashes of the device etc.

There may be other sets of information that may be extracted from the first device and the second device that are not listed above, the intent is to cover all such possible combinations and permutations that may be useful in assisting with analyzing the state of the second device.

The second device may also be profiled using the app. The device profile may extract relevant information from the second device as mentioned earlier.

The profile of the first device can then be compared with the profile of the second device. Preferably this comparison of profiles may be achieved by using a rules engine. A rules engine is a software system that executes one or more rules in a runtime environment. A rule engine may be viewed as a sophisticated if/then statement interpreter. The if/then statements that are interpreted are called rules.

A fix may be determined by comparing the settings of the two device profiles. The first device that may be working correctly may be used as a standard/reference for the profile comparison with the second device that may have encountered a problem.

This fix may then be sent from the first device to the second device using the Bluetooth connection that has been established between the two devices.

A rule may embody a condition and may use information that has been gathered from the first device for comparison with the information gathered from the second device. The rules may also preferably use reference values, standard values, target values, a range of values etc. to compare and replace values of a field on the second device.

The rule may be used to identify a value out of place in the profile of the device. The value of a field from a rule may be used to replace the value of a field in the device. Alternatively the user may be able to edit, add, delete, modify, etc. the values required in a field. In another embodiment, information may be presented e.g. a notification or a tutorial or a roaming FAQ; alternatively a remedy may be suggested to the user as a course of action. In another embodiment the performance of the second device may be fine-tuned for better utilization of existing computing power and services being consumed.

Devices that can benefit from the system may include but are not limited to a mobile device for example a Smartphone, tablet, personal data assistant (PDA), game device, e-reader, a personal computer, a server, a laptop, a tablet computer, network appliance, set-top box, SmartTV, embedded device, computer expansion module, any appliances having internet or wireless connectivity and onboard automotive devices such as navigational and entertainment systems.

The invention may take the form of a self-care app that may preferably be installed by a customer on a mobile device. The app interface may preferably provide an interface for diagnosing a peer device such that the peer device also has an app installed on it and are in communication with each other. The app may also preferably gather the device profile from the peer device and submit that along with the any other relevant information for analysis and diagnosis.

The app may also acquire and query log files and settings like SSID from the router when diagnosing a second device. For example it may check when the second device lost connection, or check the throughput of the connection, or the quality of line/WiFi signal, packet loss etc. when diagnosing the second device.

Additional information may also be acquired about the second device from the remote server of a service provider/operator/device manufacturer etc. For example subscription information about the customer account, bill payment history, list of channels subscribed by the customer, any network outages at the operator side etc. may be acquired. This additional information can also be used when diagnosing the second peer device and can be used to establish the fact that sometimes the issues/problems may reside outside of the device. For example a user may be unable to access a channel not because there is something wrong with the set-top device, but due to the fact that the user is not subscribed to that channel. Such information may be acquired from the service provider's remote server using billing and subscription information related to the account of the user associated with the second device.

As an example, consider a first device, a fully functional Smartphone, that is being used to diagnose a second device, a tablet that is unable to connect to the WiFi network. By comparing the device profiles, especially the network settings and also taking the log files and settings of the router into consideration, the root cause of the problem can be diagnosed in real time. Once the fix has been determined, the actual fix e.g. a correct WiFi network setting can be sent from the first device to the second device, where the app automatically applies this fix by updating the WiFi network setting with the correct value in the second device.

In one embodiment the system and method has the logic to apply rules to identify inaccuracies and inconsistencies in a second peer device by using the profile of a first device as a reference to fix the second device. These rules may be used to provide a suitable fix for a problem that has been encountered on the second device or may be used to fine tune the performance of the second device so that it better utilizes the computing resources and services that it consumes.

Bluetooth Low Energy (Bluetooth LE) may be a preferred wireless technology. While the preferred embodiment uses Bluetooth LE other embodiments may use wireless technologies like Bluetooth Classic, Near Field Communications (NFC), InfraRed (IR), WiFi Direct and the like instead.

Preferably the app has the capability to connect to the internet and also provides a user an interface using which the user may be able to connect to and diagnose another peer device in its vicinity.

Thus we note that the system and method provides a meaningful benefit by improving the system that helps in diagnosing and fixing a peer device for decreased dependence on the customer care departments.

According to a first aspect of the invention, a method is provided for enabling a target device to be conformed with a reference device. A peer-to-peer network connection is established between the target device and the reference device. Each device has previously installed a diagnostic application. The diagnostic application is used to profile the target device, which includes a plurality of parameter values. The diagnostic application is used to profile the reference device, which includes a plurality of parameter values. The parameter values of the target device profile are compared with the parameter values of the reference device profile to establish a delta. From this delta, at least one of the parameter values of the reference device profile is transmitted to the target device using the network connection. The parameter value of the target device is automatically reset or adjusted to match or approximate the corresponding parameter value of the reference device profile.

Preferably, in this case, the reference device and the target device have at least one characteristic in common. The at least one characteristic in common may be make, model, operating system, or firmware version.

Preferably, the comparing step is done by a rules engine. In one embodiment, the comparing step includes the reference device communicating the target device profile and the reference device profile to a server having a rules engine for comparison to establish a delta.

The delta may be displayed on the reference device. The method may also include determining at least one fix (e.g. any of the types of fixes described herein, not limited to change of values) that can be communicated from the reference device to the target device.

Preferably, the diagnostic application on the target device is programmed to implement a fix communicated from the reference device.

Preferably, the peer to peer communication network is selected from the group consisting of: Bluetooth, near-field communication, infrared, and wifi. In one particularly preferred embodiment, the peer to peer communication network is Bluetooth LE.

The method may also include comparing the parameter values of the target device profile with standard or optimal values or ranges for the parameter values. In this case, at least one of the standard or optimal values or ranges may be communicated from the reference device to the target device.

According to a second aspect of the invention, a method is provided for using a first device to mediate the diagnosis and fixing of a second device. A peer-to-peer network connection is established between the first device and the second device. Each device has previously installed a diagnostic application. The diagnostic application is used to profile the second device, which has a plurality of parameter values. The second device profile is received on the first device through the peer-to-peer network connection. The second device profile is transmitted to a server for comparison of the parameter values of the second device with standard or optimal values or ranges for the parameter values to establish a delta. An instruction is received from the server to transmit to the second device at least one of the standard or optimal parameter values to the second device, such that the diagnostic application on the second device can automatically reset or adjust its parameter value to match or approximate the standard or optimal parameter value.

The method may also include querying at least one log file related to the second device (e.g. by MAC address of the second device). The method may also include querying service history or account history related to the second device.

The method may also include querying connectivity data from a router in communication with the second device. For example, the connectivity data may include at least one of packet loss, average round-trip time, SNMP status, or bandwidth/traffic rate.

At least one fix may be received from the server that can be communicated from the first device to the second device (e.g. any of the types of fixes described herein, not limited to change of values).

Preferably, the diagnostic application on the second device is programmed to implement a fix communicated from the first device.

In certain embodiments, at the time of the comparing step, the first device has an Internet connection, while the second device does not have an Internet connection.

In certain embodiments, the second device has a more limited user interface than the first device, or the second device may have more limited user input options than the first device. (This makes the first device useful as a conduit of information and instructions for fixing the “dumber” device.)

For example, the first device may be a mobile device and the second device is a device other than a mobile device.

According to a third aspect of the invention, a method is provided for enabling a target device to be conformed with a reference device. After a wireless connection is established between a reference device and a first router, and a wireless connection is established between a target device and a second router, a remote connection is established between the target device and the reference device by sharing a pairing code between the reference device and the target device through their respective routers. Each device has previously installed a diagnostic application. The diagnostic application is used to profile the target device. The target device profile has a plurality of parameter values. The diagnostic application is used to profile the reference device. The reference device profile has a plurality of parameter values. The parameter values of the target device profile are compared with the parameter values of the reference device profile to establish a delta. From the delta that was established, at least one of the parameter values of the reference device profile is transmitted to the target device using the remote connection, and the parameter value of the target device is automatically reset or adjusted to match or approximate the corresponding parameter value of the reference device profile.

According to a fourth aspect of the invention, a method is provided for using a first device to mediate the diagnosis and fixing of a second device. After a wireless connection is established between a first device and a first router, and a wireless connection is established between a second device and a second router, a remote connection is established between the first device and the second device by sharing a pairing code between the first device and the second device through their respective routers. Each device has previously installed a diagnostic application. The diagnostic application is used to profile the second device, which has a plurality of parameter values. The second device profile is received on the first device through the remote network connection. The second device profile is transmitted to a server for comparison of the parameter values of the second device with standard or optimal values or ranges for the parameter values to establish a delta. An instruction is received from the server to transmit to the second device at least one of the standard or optimal parameter values to the second device, such that the diagnostic application on the second device can automatically reset or adjust its parameter value to match or approximate the standard or optimal parameter value.

### BRIEF DESCRIPTION OF THE FIGURES

FIG. 1 is a flow diagram illustrating a basic process for comparison of profiles and sending a fix between peer devices.

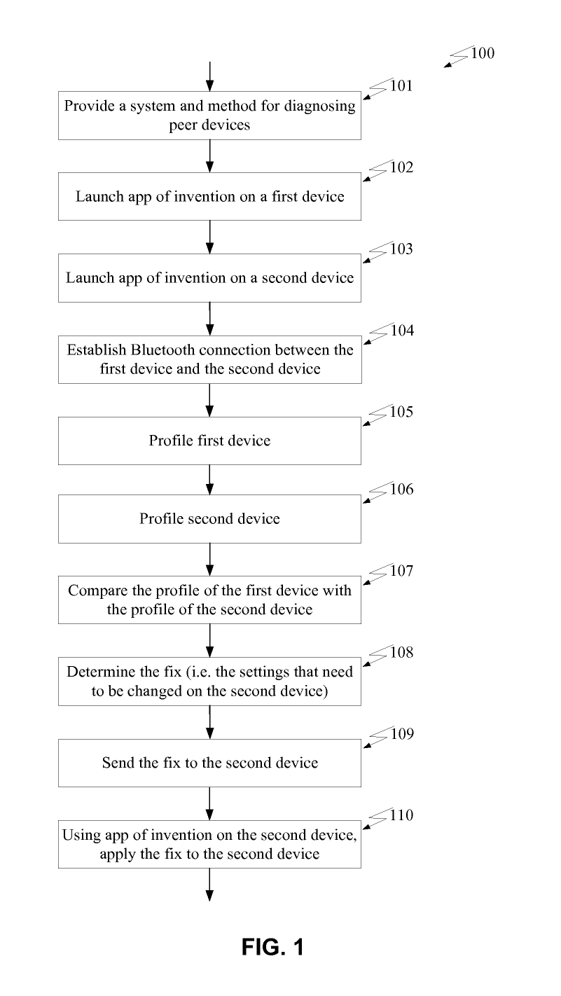

FIG. 2 is a network diagram illustrating one embodiment where a first peer device (reference device) communicates with the Internet and with a second peer device (target device) via a peer-to-peer wireless (e.g. Bluetooth) connection.

FIG. 3 is a network diagram illustrating both peer devices being compared using a remote server (with rules engine).

FIG. 4 is a flow diagram illustrating comparison of profiles and other information acquired from a router to determine a fix to send between the peer devices.

FIG. 5 is a network diagram illustrating the use of a first peer device (reference device) to query a router also in communication with a second peer device (target device) (e.g. to diagnose connectivity issues).

FIG. 6 is a network diagram illustrating both peer devices in communication with both a router and a remote server.

FIG. 7 is a flow diagram illustrating querying various sources of diagnostic data relevant to the target (second peer) device.

FIG. 8 is a flow diagram illustrating use of router and server data as well as comparison between the profiles for diagnosis.

FIG. 9 is a functional diagram of mobile device showing certain components.

### DETAILED DESCRIPTION

Before embodiments are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

it should also be understood that many components and items are illustrated and described as if they were hardware elements, as is common practice within the art. However, it will be understood that, in at least one embodiment, the components comprised in the method and tool are actually implemented in software.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a mobile device or partly on the mobile device as a stand-alone software package; partly on the mobile device and partly on a remote computer or entirely on the remote computer or server. In the latter scenario, the remote computer may be connected to the mobile device through any type of network, including a local area network (LAN) or a wide area network (WAN), or the connection may be made to the internet through a mobile operator network (e.g. a cellular network). The code is specialized to execute functions described herein which enable a smoother and more efficient technological process.

The system has been developed because the sheer volume of inquiries for diagnosis of modem devices outstrips all human ability to address each one. In this case, peer device communication/mediation and diagnostic assistance are used to avoid/reduce the need for CSR involvement, even with automated tools.

A system and method is provided for peer device diagnosis 101. As an example, let us assume that the first device (reference device) is functioning properly, while the second device (target device) is not working properly and is being diagnosed using the first device.

Another embodiment may provide a self-care app that may preferably be installed by a customer on a mobile device. The app interface may preferably provide an interface for diagnosing a peer device such that the peer device also has an app installed on it and are in communication with each other. The app may also preferably gather the device profile from the peer device and submit that along with the any other relevant information for analysis and diagnosis. One such app is described and taught in U.S. patent application Ser. No. 13/968,631, filed Aug. 16, 2013, which is incorporated herein by reference. Another related system using a device-based approach is described and taught in U.S. patent application Ser. No. 14/256,640, filed Apr. 18, 2014, which is incorporated herein by reference.

The app is launched on the first device 102. Devices that can benefit from the system may include but are not limited to a mobile device for example a Smartphone, tablet, personal data assistant (PDA), game device, e-reader, a personal computer, a server, a laptop, a tablet computer, network appliance, set-top box, SmartTV, embedded device, computer expansion module, any appliances having interact or wireless connectivity and onboard automotive devices such as navigational and entertainment systems.

The app is launched on the second device 103.

A Bluetooth connection is established between the first device and the second device 104. Bluetooth is a technology standard for exchanging data over short distances using short-wavelength radio transmissions) from fixed and mobile devices, creating personal area networks (PANs) with high levels of security. Bluetooth can connect several devices, overcoming problems of synchronization. Bluetooth is a standard wire-replacement communications protocol primarily designed for low power consumption, with a short range. Because the devices use a radio (broadcast) communications system, they do not have to be in visual line of sight of each other.

In one embodiment Bluetooth Low Energy (Bluetooth LE) may be the preferred wireless technology of choice, Bluetooth LE is a wireless personal area network technology designed and marketed as Bluetooth Smart by the Bluetooth Special Interest Group. Compared to Classic Bluetooth, Bluetooth Smart is intended for considerably reduced power consumption and lower cost while maintaining a similar communication range. Mobile operating systems including iOS, Android, Windows Phone and BlackBerry, as well as OS X, Linux, and Windows 8, natively support Bluetooth Smart. Bluetooth Smart uses the same 2.4 GHz radio frequencies as Classic Bluetooth, which allows dual-mode devices to share a single radio antenna.

A master Bluetooth device can communicate with a maximum of seven devices in a piconet (an ad-hoc computer network using Bluetooth technology), though not all devices reach this maximum. The devices can switch roles, by agreement, and the slave can become the master.

At any given time, data can be transferred between the master and one other device (except for the less-used broadcast mode). The master chooses which slave device to address; typically, it switches rapidly from one device to another in a round-robin fashion.

Any Bluetooth device in discoverable mode will transmit the following information on demand:

Device name

Device class

List of services

Technical information (for example: device features, manufacturer, Bluetooth specification used, clock offset)

Any device may perform an inquiry to find other devices to connect to, and any device can be configured to respond to such inquiries. However, if the device trying to connect knows the address of the device, it always responds to direct connection requests and transmits the information shown in the list above if requested. Use of a device's services may require pairing or acceptance by its owner, but the connection itself can be initiated by any device and held until it goes out of range. Some devices can be connected to only one device at a time, and connecting to them prevents them from connecting to other devices and appearing in inquiries until they disconnect from the other device.

Every device has a unique 48-bit address. However, these addresses are generally not shown in inquiries. Instead, friendly Bluetooth names are used, which can be set by the user. This name appears when another user scans for devices and in lists of paired devices. By default most phones have the Bluetooth name set to the manufacturer and model of the phone.

While the preferred embodiment uses Bluetooth LE, in other embodiments wireless technologies like Bluetooth Classic, Near Field Communications (NFC), InfraRed (IR), WiFi Direct and the like may be used instead.

The first device is profiled 105. The app may have an agent that has the capability to provide a user with an interface using which the user may be able profile a device in order to diagnose another peer device.

Information that can be gathered from the device may include but is not limited to: the device make, model and manufacture information, OS and firmware versions; applications (commonly referred to as “apps”) installed on the device; apps and processes running on the device; certificates on the device; user profile information; the character of any passcode used to authenticate a user (e.g. whether a password/passcode is used and the relative strength of that password, such as the number of characters); information regarding whether the device operating system has been tampered with by the user (e.g. an iOS device has been jailbroken, or a Google Android device has been rooted); and the data usage e.g. the amount of MB or GB used for a given billing period, the amount data used while roaming, or the relative amount compared to a data plan used by the user.

In one embodiment the device profile for example may provide device make, device model, OS version, language, operator, location, settings etc.:

Device Make=Samsung

Device Model=Galaxy S4

Operating System=Android 4.2.2

Language=English

Operator=Sprint

Location=New York, N.Y. USA

MMSC=http://mms.sprintpcs.com/servlets/mms

The system and method may also extract and add to the device profile by adding data from the error logs for example types of errors, number of errors in an error log, severity of errors, number and frequency of crashes of the device etc.

There may be other sets of information that may be extracted from the device that are not listed above, the intent is to cover all such possible combinations and permutations that may be useful in assisting with analyzing the state of the device.

The second device is profiled 106. This may be done using the app installed on the second device. The device profile may extract relevant information about the device as mentioned earlier.

The profile of the first device may be compared with the profile of the second device 107. This comparison may be achieved by using a rules engine. A rules engine is a software system that executes one or more rules in a runtime environment. A rule engine may be viewed as a sophisticated if/then statement interpreter. The if/then statements that are interpreted are called rules. Some exemplary rules engines are described in U.S. Ser. Nos. 13/968,631 and 14/256,640, both incorporated herein by reference.

In one embodiment the app may have the agent and the rules engine embedded in it while also providing a user interface using which a user may be able to initiate a request for a Bluetooth connection, profile gathering, and peer device diagnosis.

In another embodiment the rules engine and the rules may be on a remote server. If there are no rules in the rules repository that match the problem being encountered by a customer, no rules will fire. Therefore new rules need to be added to the system continuously as new devices are launched and new problems are encountered.

In one embodiment the system and method has the logic to apply rules to identify inaccuracies and inconsistencies in a peer device. These rules may be used to compare the settings of the two peer devices and provide a suitable fix to a problem that has been encountered on the second device or may be used to fine tune the performance of the second device so that it better utilizes the computing resources and services that it consumes.

A rules engine can make it easy to express solutions to difficult problems and consequently have those solutions verified as rules which are much easier to read than code. Rule systems are capable of solving complex problems, providing an explanation of how the solution was arrived at and why each decision along the way was made.

A rules engine provides an efficient way of matching rule patterns to the domain knowledge. By using rules a repository of knowledge (a knowledgebase) is created which is executable; meaning that it's the single point of truth when verification for some items may be required.

A rule consists of some number of conditions and some number of actions. Generally the rules are written in a high-level business language that relates to the domain, storing the rules in the repository. The Rules Repository may also include proto-rules i.e. rules not completely validated yet for implementation. A database may be used as the preferred and exemplary embodiment to store the rules. In another embodiment the rules may be stored in a list, in a table or other method that may be suitable for so doing.

A rule can generally be represented as IF CONDITION(S) THEN RECOMMENDATION(S)/FIX(ES). It can consist of one or more conditions (the “IF”). One or more conditions can be grouped together by “and” and “or” and the order of operations can be further defined using brackets. In each condition, there could be a device attribute, a conditional operator (=, >, <, !=, exists, not exists) and then a text box in which to enter static text, numeric, date-time value or another device attribute. These conditions can then be rearranged, grouped, and joined together to form a bigger condition.

A rule should also contain a recommendation or a fix (the “THEN”). When saved, the rules will follow the Rules Lifecycle (status including but not limited to DRAFT, PENDING, VALIDATION, REJECTED, VALIDATED (Nth), ACTIVE, INACTIVE) and only active rules may be disseminated to other sources. The scope of a rule can be system-wide, device-specific, model-specific, manufacturer-specific, operator-specific, build-specific, condition-specific, setting-specific etc.

In one embodiment each rule may embody the actual, required values for the different fields e.g. SMTP Server, Gateway IP addresses, APN, Build Versions, User name, Passwords, list of malicious apps, etc. The actual values may be seeded in a rule or could be obtained from another source either on the server or on the device. In one embodiment the execution of the rules allows for the comparison of the values found on the device with the values in the rules. If the values are the same, i.e. the value of a field in the device and the value of the field in the rule are equal it is concluded that the rule has passed and that no fix may be required. If the two values, i.e. the value of a field in the device and the value of the field in the rule, are NOT equal it is concluded that the device is in need of a fix and the value of the field in the device is replaced with the value of field in the rule. An appropriate fix is determined (e.g. the settings that need to be changed on the second device) 108 by comparing the setting of the two device profiles. The first device that may be working correctly may be used as a standard for the profile comparison with the second device that may have encountered a problem.

The fix is sent to the second device 109. The fix may be sent to the second device using the Bluetooth connection that has been established between the two devices.

Using the app on the second device, the fix may be applied to the second device 110.

In one embodiment a rule may embody a condition and may use information that has been gathered from the first device for comparison with the information gathered from the second device. The rules may also preferably use reference values, standard values, target values, a range of values etc. to compare and replace values of a field on the second device.

In one embodiment replace the value of a field from a rule to the value of a field in the device. Alternatively provide a solution where the user may be able to edit, add, delete, modify, etc. the values required in a field. In another embodiment present information e.g. a notification or a tutorial or a roaming FAQ; alternatively suggest a remedy to the user as a course of action. In another embodiment fine tune the performance of the device for better utilization of existing computing power and services being consumed.

It is to be understood that the rules engine is not necessarily linear when executing the rules. There may be a common starting point when executing the rules, but as the rules get executed and as information gathered from the device is analyzed, one rule may trigger another rule that may be part of another set of rules. There may also be loops, so that there are rules embedded within rules, or a rule many call another rule as part of its execution. The rule that is called from within the loop or the rule that is called as part of the execution of another rule may not be fixed or static but may depend on the situation and vary as needed.

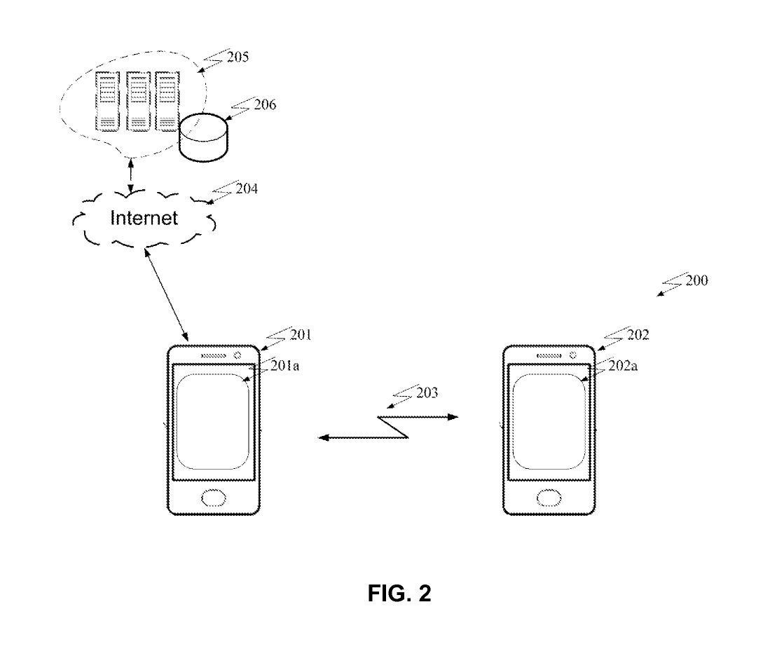

FIG. 2 shows one embodiment 200. The first peer device 201 e.g. a Smartphone has the app installed and launched on it 201a.

The second peer device 202 e.g. another Smartphone has the app installed and launched on it 202a.

The Bluetooth wireless connection between the two peer devices is depicted by 203.

First peer device 201 may he connected to the interact 204 via WiFi or a cellular data connection and be able to access the remote server 205 that may have a database of rules 206.

in one embodiment a first peer device 201 may connect to the remote server 205 either in real time when diagnosing the second peer device 202 to update the rules cached in its local memory to the latest set from the rules database 206.

In another embodiment a first device may connect to the remote server 205 periodically and update the rules cached in its local memory to the latest set from the rules database 206.

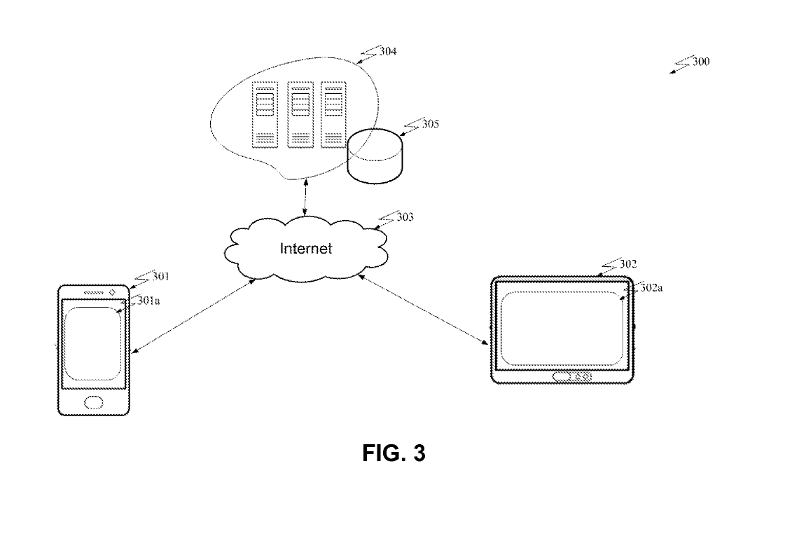

FIG. 3 shows one embodiment 300. The first peer device 301 e.g. a Smartphone has the app installed and launched on it 301a.

The second peer device 302 e.g. tablet computer has the app installed and launched on it 302a.

The first peer device 301 and the second peer device 302 may both be connected to the internet 303 via WiFi or a cellular data connection and be able to access the remote server 304 that may have a database of rules 305.

In one embodiment the first device and the second device both send their respective profiles to the server and the server compares the profiles and sends the fix back.

In another embodiment the first device receives the profile of the second device via the remote server and does a local compare and then sends the fix to the server which in turn sends the fix back to the second device.

Such an embodiment may be useful when the two peer devices are either unable to create a Bluetooth connection or a similar wireless connection either due to a problem or due to the fact that they may not be in each other's vicinity.

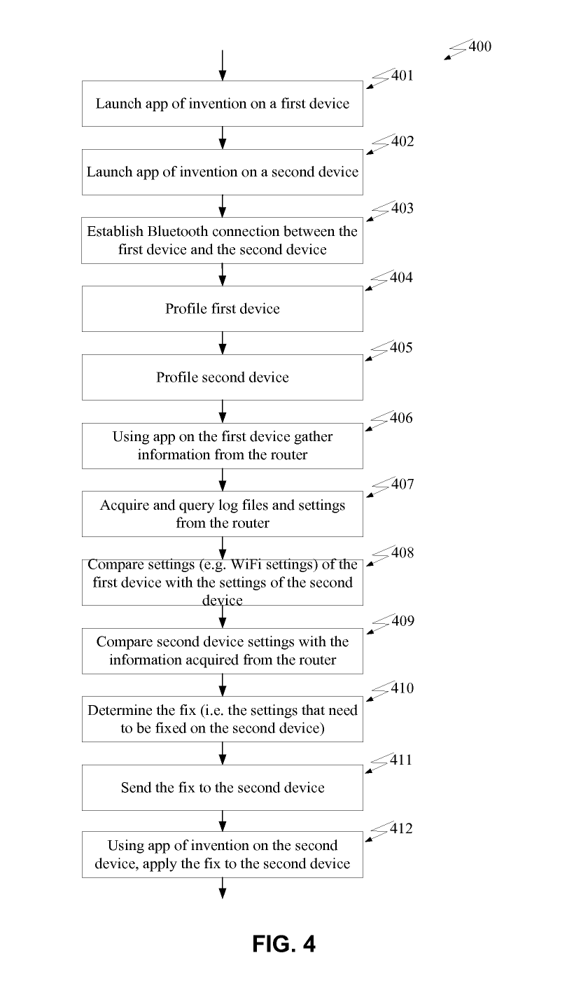

FIG. 4 shows one embodiment 400. The app is launched on a first device 401. The first device for example may be a Smartphone.

The app is launched on a second device 402. The second device for example may be a tablet.

A Bluetooth connection is established between the first device and the second device 403.

The first device is profiled 404. The second device is profiled 405.

Using the app on the first device information is gathered from the router 406.

Log files may be acquired and queried from the router 407. Settings like SSID may also be acquired and queried from the router.

Log files can be accessed from a router's management interface which is usually accessed via a web browser and the address of 192.168.1.X. or something similar. The default IF address for most routers is “192.168.0.1”. A user may be prompted to enter the administrator password, if the router has a password. Some routers have a “Save logs” button for exporting the logs to a text file. Thus the log file could be exported as a text file and then the relevant information extracted from this text file.

From the “Status” section of the router's interface the DHCP log can be acquired which shows the network addresses of devices connected to the network. The security logs are generally under the section of the interface labeled “Security”.

The logs will have rows and columns of IP addresses and MAC addresses. IP address is the address of the connected device. The MAC address is the hardware address of the Network Interface Card, or NIC for the connected device. Any device on the network may have a MAC address, but not device may have an IP address. Other information like time and duration port number, can also be available, but may be a little different between manufacturers.

Other information that may be acquired from the router may include but is not limited to packet loss, average round-trip time, SNMP status information, bandwidth/traffic rate, as well as packet loss.

Settings (e.g. WiFi settings) of the first device are compared with e settings of the second device 408.

Second device settings may also be compared with the information acquired from the router 409, e.g. log files and settings.

An appropriate fix is determined (e.g. the settings that need to be fixed on the second device) 410. For example the settings for MMSC on the second device may be incorrect, and thus the system may get the MMSC settings from the first device, compare them with the settings from the second device so that it can be determined which of the settings is incorrectly set on the second device.

The fix is sent to the second device 411. The fix may be sent from the first device to the second device using the Bluetooth connection. In one embodiment the fix may only include the setting(s) that are incorrect. In another embodiment all of the settings may be sent.

Using the app on the second device, the fix may be applied to the second device 412. Thus the second device receives the settings from the first device and replaces the setting on the second device with the settings received from the first device to fix the problem.

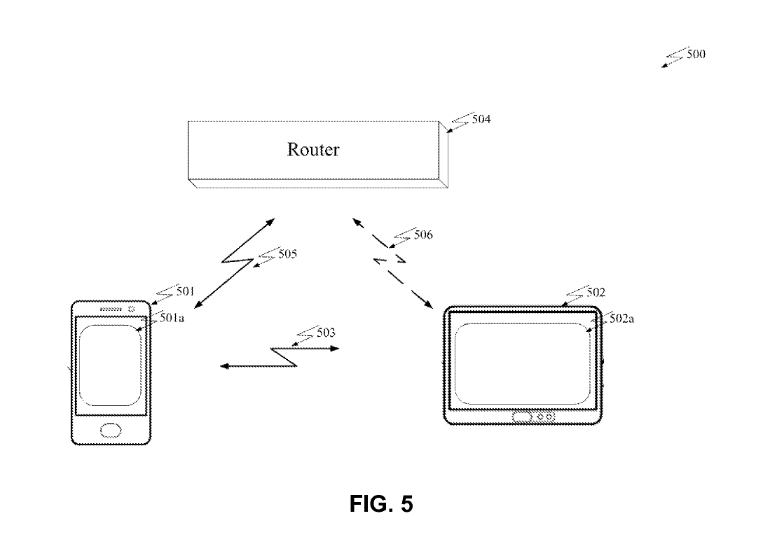

FIG. 5 shows one embodiment 500. The first peer device 501 e.g. a Smartphone has the app installed and launched on it 501a.

The second peer device 502 e.g. tablet computer has the app installed and launched on it 502a.

The first peer device 501 and the second peer device 502 are connected via a wireless connectivity technology e.g. WiFi Direct 503. WiFi Direct is a WiFi standard that enables devices to connect with each other without requiring a wireless access point. WiFi Direct provides the ability to connect devices even if they are from different manufacturers. Only one of the WiFi devices needs to be compliant with WiFi Direct to establish a peer-to-peer connection that transfers data directly between each other with greatly reduced setup.

The first peer device 501 is connected to the router 504 and this WiFi connection is depicted by 505. The second peer device 502 is unable to connect to the router 504, and this lack of connection or broken connection is depicted by 506.

In one embodiment the first device 501 gathers the profile of the second peer device 502 via the WiFi Direct connection 503. In addition the first peer device 501 also gathers information from the router 504 e.g. log files and error files. Thus the first peer device 501 when comparing the profiles may also take into account the information gathered from the router 504.

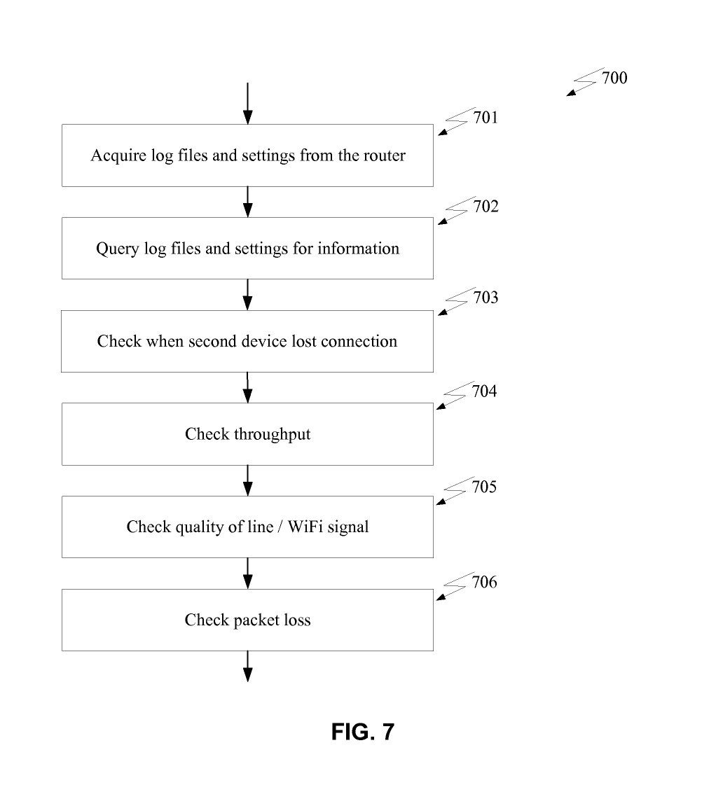

The process of acquiring of the log files, settings etc. from the router and their use is described in more detail using FIG. 7.

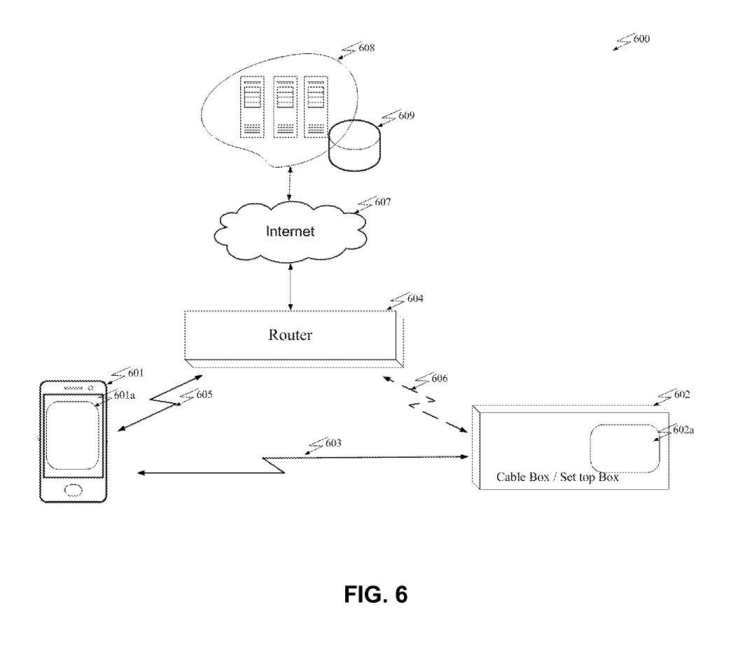

FIG. 6 shows one embodiment 600. The first peer device 601 e.g. a Smartphone has the app installed and launched on it 601a.

The second peer device 602 e.g. a cable box or a set-top box has the app installed and launched on it 602a.

The first peer device 601 and the second peer device 602 are connected via Bluetooth 603.

The first peer device 601 is connected to the router 604 and this connection WiFi connection is depicted by 605. The second peer device 602 is unable to connect to the router 604, and this lack of connection or broken connection is depicted by 606.

In one embodiment the first device 601 gathers the profile of the second peer device 602 via the Bluetooth connection 603. In addition the first peer device 601 also gathers information from the router 604 e.g. log files and error files.

The first device 601 is connected to the internet 607 via the router 604. The remote server 608 and the database of rules 609 are accessible to the first device 601.

In one embodiment the profiles gathered from the first device 601 and the second device 602 and the information gathered from the router 604 is sent to the remote server 608.

Optionally additional information may also he acquired from the remote server, for example acquire subscription information about the customer account, bill payment history, list of channels subscribed by the customer, any network outages at the operator side etc. This additional information may also be used when diagnosing the second peer device and can be used to establish the fact that sometimes the issues/problems may outside of the device. For example a user is unable to access a channel not because there is something wrong with the set-top device, but due to the fact that the user is not subscribing to that channel. Such information may be acquired from the service provider's remote server using billing and subscription information related to the account of the user.

FIG. 7 shows one embodiment 700. Log files and settings are acquired from the router 701.

Log files and settings are queried for information 702.

The system may check when the second device lost connection 703. If it is determined that the second device lost connection when it was experiencing the issue, it can be determined that problem is not with the device but perhaps the second device was moved to a new location with poor or no connectivity.

The system may check the throughput 704 of the connection. If it is determined that the throughput of the channel is low, then it can determined that the problem is not with the device but perhaps it is not connected to the right channel. For example instead of being connected to a 5 GHz connection it is connected to a 2.4 GHz connection.

The system may check the quality of the line/WiFi signal 705. If it is determined that the quality of line is poor or that the WiFi signal strength is poor, then it can be determined that the problem is not with the device but perhaps with its location.

The system may check for any packet loss 706. If it can be determined that there is significant packet loss, then it can be determined that the problem is not with the device but perhaps the router.

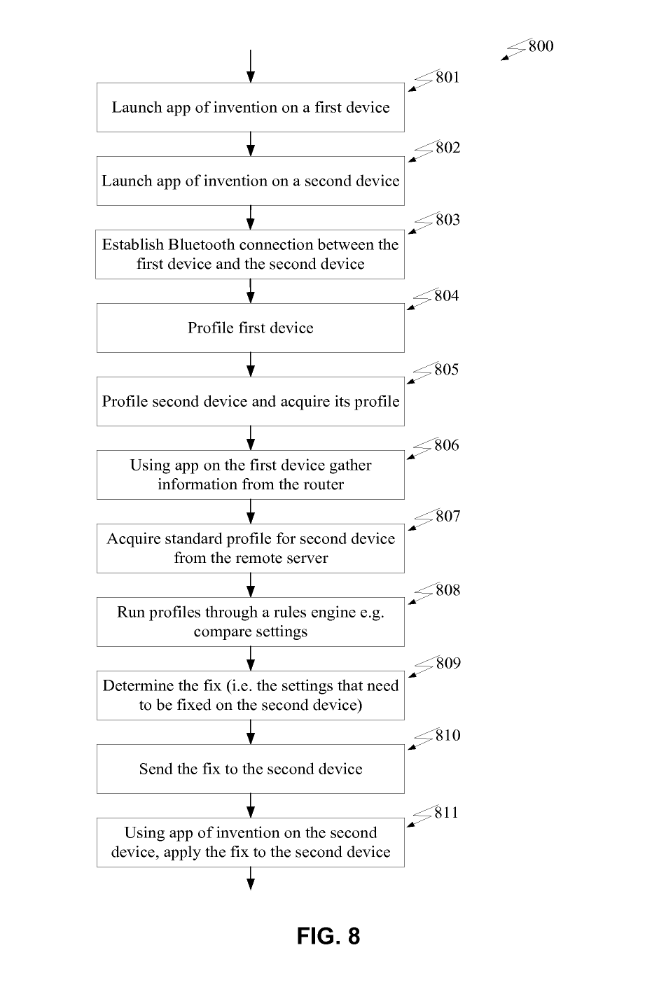

FIG. 8 shows one embodiment 800. The app is launched on a first device 801. The app is launched on a second device 802.

A Bluetooth connection is established between the first device and the second device 803. In one embodiment the Bluetooth connection request may be initiated by a user. In another embodiment the Bluetooth connection request may be initiated by the app when the app is launched.

The first device is profiled 804. The second device is profiled and the first device acquires its profile 805.

Using the app on the first device the system gathers information from the router 806.

The system also acquires a standard (or optimal) profile for second device from the remote server 807. In such an embodiment the profiles acquired from the first device, and the standard/reference profile for a generic second device are used for comparing the profile of the second device so that any settings that are not correctly set may be identified and fixed.

The profiles are run through a rules engine e.g. compare settings 808. In one embodiment the profiles acquired from the first device, the standard/reference profile for a generic second device and the profile of the second device, are run through a rules engine e.g. compare settings of the different profiles and identify the settings that are not correct.

An appropriate fix is determined (i.e. the settings that need to be fixed on the second device) 809.

The fix is sent to the second device 810 for example using the Bluetooth connection to send the fix from the first device to the second device.

Using the app on the second device, the system applies the fix to the second device 811. For example the system may replace, edit, add, or delete any one or more settings on the second device as needed.

In some embodiments, the two devices may be remote from each other, and may not have a peer-to-peer network connection as such. However, the first device may be connected to its router through a WiFi connection, and the second device may be connected to its respective router through a WiFi connection. The two devices may then be bound together by sharing a pairing code (or passcode). Once both devices are connected to each other (via their respective wireless connections with their respective routers), the first device may diagnose and send fixes to the second peer device. Or in some embodiments, diagnosis may be done remotely at a server in communication with the first device (e.g. to conform one or more of the second device's settings to standard or reference values or a standard or reference “profile”), and the first device may be used as a conduit for transmitting a fix to the second device.

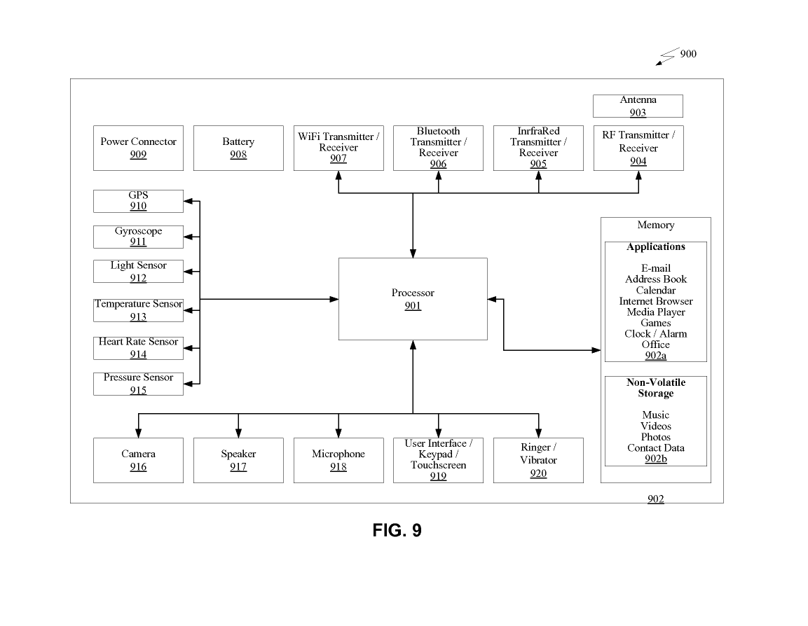

FIG. 9 depicts an exemplary block diagram of a mobile device 900. Exemplary electronic circuitry of a typical mobile phone is shown; other devices may differ and may either omit or have electronic components not shown here. The mobile device 900 includes one or more microprocessors 901, which is electronically coupled to other electronic components such as memory 902 (e.g., non-volatile memory such as ROM and volatile memory such as RAM) which stores processor-readable code which is executed by one or more processors of the control processor 901 to implement the functionality described herein.

Mobile device 900 may include, for example, processors 901, memory 902 including applications 902a and non-volatile storage 902b. The processor 901 can implement communications, as well any number of applications, including the interaction gaming applications discussed herein. Memory 902 can be any variety of memory storage media types, including non-volatile and volatile memory. A device operating system handles the different operations of the mobile device 900 and may contain user interfaces for operations, such as placing and receiving phone calls, text messaging, multi-media messaging, checking voicemail, e-mail, games and the like. The applications 902a can be any assortment of programs, such as a camera application for photos and/or videos, an address book, a calendar application, a media player, an internet browser, games, an alarm application, other third party applications, the gaming applications discussed herein, and the like, The non-volatile storage component 902b in memory 902 contains data such as web caches, music, photos, contact data, scheduling data, and other files.

The processor 901 also communicates with RF transmitter/receiver circuitry 903 which in turn is coupled to an antenna 904, with an infrared transmitter/receiver 905, with a Bluetooth transmitter/receiver 906 a WiFi transmitter/receiver 907, a battery 908, a power connector 909, a GPS 910, a gyroscope 911, a light sensor 912, a temperature sensor 913, a heart rate sensor 914, a pressure sensor 915, a camera 916, a speaker 917, a microphone 918, a user interface/keyboard or a touchscreen 919, and a ringer/vibrator 920.

The processor 901 also communicates with Infrared transmitter/receiver circuitry 905. The way this technology works is that the infrared transmit component flashes an infrared light in a particular pattern, which another component (the infrared receiver) can pick up and translate into an instruction. These transmitters and receivers are also typically found in remote controls and are now embedded in mobile devices that can turn them into remote control devices. They typically generate infrared using light emitting diodes (LEDs), and the main component of a receiver unit is usually a photodiode.

The processor 901 also communicates with Bluetooth transmitter/receiver circuitry 906. Bluetooth is a standard wire-replacement communications protocol primarily designed for low power consumption, with a short range. Bluetooth provides a secure way to connect and exchange information between devices such as mobile phones, laptops, personal computers etc. A Bluetooth-enabled mobile device is able to pair with many other devices for communications. In the present invention, Bluetooth capability is used to establish a peer-to-peer connection between devices for device diagnosis and to provide fixes for device issues to a second device (which may be another mobile device, e.g. smartphone, or a non-smartphone device).

The processor 901 also communicates with WiFi transmitter/receiver circuitry 907. WiFi is a technology that allows an electronic device to exchange data or connect to the internet wirelessly using radio frequencies. Thus the embedded WiFi transmitter/receiver circuitry 907 in a mobile device allows it to connect to the internet for communications. A Wi-Fi-enabled mobile device can connect to the Internet when within range of a wireless network which is configured to permit this.

A battery 908 provides a power source to operate the different electronic components in the mobile device 900. An electric battery is a device consisting of one or more electrochemical cells that convert stored chemical energy into electrical energy. Typically the battery 908 is a rechargeable battery.

The processor 901 controls transmission and reception of wireless signals. During a transmission mode, the processor 801 provides a voice signal from microphone 918, or other data signal, to the RF transmitter/receiver circuitry 903, The RF transmitter/receiver circuitry 903 transmits the signal to a remote station (e.g., a fixed station, operator, other cellular phones, etc.) for communication through the antenna 904. The ringer/vibrator 920 is used to signal an incoming call, text message, calendar reminder, alarm clock reminder, or other notification to the user. During a receiving mode, the RF transmitter/receiver circuitry 903 receives a voice or other data signal from a remote station through the antenna 904. A received voice signal is provided to the speaker 917 while other received data signals are also processed appropriately.

A physical power connector 909 can be used to connect the mobile device 900 to an external power source, such as an AC adapter or powered docking station. In some cases the same physical connector as the power connector 909 can also be used as a data connection to a computing device (e.g. on an iPhone). The data connection allows for operations such as synchronizing mobile device data with the computing data on another device.

A global positioning service (GPS) receiver 910 utilizing satellite-based radio navigation to relay the position of the user applications enabled for such service.

A gyroscope 911 is a device for measuring or maintaining orientation, based on the principles of angular momentum and allows for more accurate recognition of movement within a 3D space. Gyroscopes in consumer electronics are frequently combined with accelerometers (acceleration sensors) for more robust direction- and motion-sensing.

A light sensor 912, is a device for sensing light and may be used for automatically adjusting the brightness of the screen back-light both to improve battery life and make it easier to see the screen.

A temperature sensor 913 is a device for sensing and measuring temperature. A heart rate sensor 914 is a device for sensing and measuring the heart rate. A pressure sensor 915, is a device for sensing and measuring the pressure.

A camera 916 is a device for capturing video images (still and motion). Cameras embedded in mobile devices like mobile phones can capture and share pictures almost instantly and automatically. This enables services like multi-media messaging, video calling, and the like. The cameras embedded in mobile devices like smartphones may also be used as input devices in numerous applications, e.g. reading QR codes; where the QR codes can be sensed by the mobile device using its camera and provide a link to related digital content, via a URL.

A speaker 917 is a device that converts electrical signals into sound. A speaker on a mobile device is used for communications that is relaying the sound of the remote party as RE signals received via the antenna 904, coupled to the RE transmitter/receiver 903 and processed by the processor 901. A speaker may also be used for playing the audio e.g. music that may be stored on the mobile device or may be streaming using internet communications.

A microphone 918 is a device that converts sound signals into electrical signals. A microphone on a mobile device is used for communications by converting the sound of the user to the remote party. Sound signals converted to electrical signals are relayed to the remote party as RE signals received via the antenna 904, coupled to the RE transmitter/receiver 903 and processed by the processor 901.

A user interface/keyboard or a touchscreen 919, are among the many different methods for receiving input from a user and converting this input into the appropriate electrical signals to be processed by the processor 901. Most Smartphones these days have a touchscreen that enables a user to touch and provide an input e.g. typing text, or playing a game using gestures.

A ringer/vibrator 920 is used for alerting a user of any incoming or outgoing communications, e.g. an incoming call, an outgoing e-mail.

It should be understood that although the term application has been used as an example in this disclosure but in essence the term may also imply to any other piece of software code where the embodiments are incorporated. The software application can be implemented in a standalone configuration or in combination with other software programs and is not limited to any particular operating system or programming paradigm described here.

Several exemplary embodiments/implementations have been included in this disclosure. The application is not limited to the cited examples, but the intent is to cover all such areas that may be benefit from this invention.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method of enabling a target device to be conformed with a reference device, comprising:
establishing a peer-to-peer network connection between the target device and the reference device, each device having previously installed a diagnostic application;
using the diagnostic application to profile the target device, the target device profile having a plurality of parameter values;
using the diagnostic application to profile the reference device, the reference device profile having a plurality of parameter values;
comparing the parameter values of the target device profile with the parameter values of the reference device profile to establish a delta; and
from the delta that was established, transmitting at least one of the parameter values of the reference device profile to the target device using the peer-to-peer network connection, and automatically resetting or adjusting the parameter value of the target device to match or approximate the corresponding parameter value of the reference device profile.

2. The method of claim 1, wherein the reference device and the target device have at least one characteristic in common.

3. The method of claim 2, wherein the at least one characteristic in common is make, model, operating system, or firmware version.

4. The method of claim 1, wherein the comparing step is done by a rules engine.

5. The method of claim 1, wherein the comparing step includes the reference device communicating the target device profile and the reference device profile to a server having a rules engine for comparison to establish a delta.

6. The method of claim 1, further comprising displaying the delta on the reference device.

7. The method of claim 1, further comprising determining at least one fix that can be communicated from the reference device to the target device.

8. The method of claim 7, wherein the diagnostic application on the target device is programmed to implement a fix communicated from the reference device.

9. The method of claim 1, wherein the peer to peer communication network is selected from the group consisting of: Bluetooth, near-field communication, infrared, and wifi.

10. The method of claim 1, wherein the peer to peer communication network is Bluetooth LE.

11. The method of claim 1, further comprising comparing the parameter values of the target device profile with standard or optimal values or ranges for the parameter values.

12. The method of claim 11, further comprising communicating at least one of the standard or optimal values or ranges from the reference device to the target device.

13. A method of using a first device to mediate the diagnosis and fixing of a second device, comprising:
establishing a peer-to-peer network connection between the first device and the second device, each device having previously installed a diagnostic application;
using the diagnostic application to profile the second device, the second device profile having a plurality of parameter values;
receiving the second device profile on the first device through the peer-to-peer network connection;
transmitting the second device profile to a server for comparison of the parameter values of the second device with standard or optimal values or ranges for the parameter values to establish a delta; and
receiving an instruction from the server to transmit to the second device at least one of the standard or optimal parameter values, such that the diagnostic application on the second device can automatically reset or adjust its parameter value to match or approximate the standard or optimal parameter value.

14. The method of claim 13, further comprising querying at least one log file related to the second device.

15. The method of claim 14, further comprising querying by MAC address of the second device.

16. The method of claim 13, further comprising querying service history or account history related to the second device.

17. The method of claim 13, further comprising querying connectivity data from a router in communication with the second device.

18. The method of claim 17, wherein the connectivity data includes at least one of packet loss, average round-trip time, SNMP status, or bandwidth/traffic rate.

19. The method of claim 13, further comprising receiving from the server at east one fix that can be communicated from the first device to the second device.

20. The method of claim 19, wherein the diagnostic application on the second device is programmed to implement a fix communicated from the first device.

21. The method of claim 13, wherein, at the time of the comparing step, the first device has an Internet connection, and the second device does not have an Internet connection.

22. The method of claim 13, wherein the second device has a more limited user interface than the first device.

23. The method of claim 13, wherein the second device has more limited user input options than the first device.

24. The method of claim 13, wherein the first device is a mobile device and the second device is a device other than a mobile device.

25. A method of enabling a target device to be conformed with a reference device, comprising:
establishing a wireless connection between a reference device and a first router;
establishing a wireless connection between a target device and a second router;
establishing a remote connection between the target device and the reference device by sharing a pairing code between the reference device and the target device through their respective routers, each device having previously installed a diagnostic application;
using the diagnostic application to profile the target device, the target device profile having a plurality of parameter values;
using the diagnostic application to profile the reference device, the reference device profile having a plurality of parameter values;
comparing the parameter values of the target device profile with the parameter values of the reference device profile to establish a delta;
from the delta that was established, transmitting at least one of the parameter values of the reference device profile to the target device using the remote connection, and automatically resetting or adjusting the parameter value of the target device to match or approximate the corresponding parameter value of the reference device profile.

26. A method of using a first device to mediate the diagnosis and fixing of a second device, comprising:
establishing a wireless connection between a first device and a first router;
establishing a wireless connection between a second device and a second router;
establishing a remote network connection between the first device and the second device by sharing a pairing code between the first device and the second device through their respective routers, each device having previously installed a diagnostic application;
using the diagnostic application to profile the second device, the second device profile having a plurality of parameter values;
receiving the second device profile on the first device through the remote network connection;
transmitting the second device profile o a server for comparison of the parameter values of the second device with standard or optimal values or ranges for the parameter values to establish a delta; and
receiving an instruction from the server to transmit to the second device at least one of the standard or optimal parameter values, such that the diagnostic application on the second device can automatically reset or adjust its parameter value to match or approximate the standard or optimal parameter value.
